(19) United States
(12) Patent Application Publication
(10) Pub. No.: US 2025/0389278 A1
(43) Pub. Date: Dec. 25, 2025

(54) FAN BLADES AND MODIFICATIONS THEREOF

(71) Applicant: Delta T, LLC, Lexington, KY (US)

(72) Inventors: Jay Fizer, Lexington, KY (US); Shankar Narayana, Lexington, KY (US); Michael Smith, Lexington, KY (US); Jayme Webb, Lexington, KY (US)

(21) Appl. No.: 18/842,128

(22) PCT Filed: Feb. 28, 2023
(86) PCT No.: PCT/US2023/014103

§ 371 Date: Aug. 28, 2024

Related U.S. Application Data
(60) Provisional application No. 63/314,937, filed on Feb. 28, 2022.

(51) Int. Cl. F04D 29/34; F04D 25/08; F04D 29/32; F04D 29/38

(52) U.S. Cl. CPC F04D 29/34; F04D 25/088; F04D 29/325; F04D 29/384

(57) ABSTRACT

A fan blade adapted for connecting to a mount includes a body having an airfoil shape in cross-section, the body including a hollow portion having a lower surface and a. solid portion depending from the body to a location below the lower surface when the fan blade is connected to the mount. A winglet may be attached to one end of the body, and may include a portion having an airfoil shape in cross-section. The winglet may comprise a body including a mount for connecting to the fan blade. The body may further include a generally vertical portion having a. greater surface area, below the mount than above the mount. The body may have a portion angled in both a vertical direction and in plan view, such as along a leading edge, trailing edge, or both. The fan blade may be extruded from aluminum.

This application claims the benefit of U.S. Provisional Patent Application Ser. No. 63/314,937, filed Feb. 28, 2022, the disclosure of which is incorporated herein by reference.

This application is related to U.S. Pat. Nos. 6,244,821, 6,939,108, 7,252,478, 7,284,960, 8,079,823 and D587,799 and also U.S. Pat. Pub. Nos. 2008/0008596, 2008/0014090, 2009/0081045, 2009/0072108, 2009/0208333, 2010/0104461, and 2010/0278637, the disclosures of which are incorporated herein by reference.

### TECHNICAL FIELD

This document relates generally to the fan arts and, more particularly, to ceiling fans. More specifically, this disclosure relates to fan blades and fan blade modifications, and is particularly directed to an airfoil suitable for use as a fan blade, winglets suitable for use with a fan blade, a fan blade attachment for use in connection with a fan blade, and any combination of the foregoing.

### BACKGROUND

People working in large structures such as warehouses and manufacturing plants may be exposed to working conditions that range from being uncomfortable to hazardous. The same may also apply in agricultural settings, such as in a structure housing livestock. On a hot day, the inside air temperature may reach a point where a person or other animal is unable to maintain a healthy or otherwise desirable body temperature. In areas where temperatures are uncomfortably or unsafely high, it may be desirable to have a device operable to create or enhance airflow within the area. Such airflow may, in part, facilitate a reduction in temperature in the area.

Moreover, some activities that occur in these environments, such as welding or operating internal combustion engines, may create airborne contaminants that can be deleterious to those exposed. The effects of airborne contaminants may be magnified if the air flow in the area is less than ideal. In these and similar situations, it may be desirable to have a device operable to create or enhance airflow within the area. Such airflow may, in part, facilitate the reduction of deleterious effects of contaminants, such as through dilution and/or removal of contaminants.

In certain structures and environments, a problem may arise with heat gathering and remaining near the ceiling of the structure. This may be of concern where the area near the floor of the structure is relatively cooler. Disadvantages may arise from having this or other types of imbalanced air/temperature distribution. In these and similar situations, it may be desirable to have a device operable to create or enhance airflow within the area. Such airflow may, in part, facilitate de-stratification and the inducement of a more ideal air/temperature distribution.

It may also be desirable to have a fan capable of reducing energy consumption. Such a reduction of energy consumption may be effected by having a fan that runs efficiently e.g., less power is required to drive the fan as compared to other fans. A reduction of energy consumption may also be effected by having a fan that improves air distribution, thereby reducing heating or cooling costs associated with other devices.

### SUMMARY

According to one aspect of the disclosure, a fan blade adapted for connecting to a mount is provided. The fan blade comprises a body having an airfoil shape in cross-section, the body including a hollow portion having a lower surface and a solid portion depending from the body to a location below the lower surface when the fan blade is connected to the mount.

In one embodiment, the body has an angle of attack between about 8 degrees and about 9 degrees. The body may have a chord length of about 6 inches to about 7 inches. More particularly, the chord length of the body may be about 6.5 inches.

The hollow portion of the fan blade may comprise one or more mounting bosses for engaging a tab of a hub. The solid portion may depend at an angle of approximately 25° relative to portion of the lower surface of the hollow portion.

A winglet may be attached to one end of the body. The winglet may comprise a portion having an airfoil shape in cross-section. The winglet may comprise a body including a mount for connecting to the fan blade, the body further including a generally vertical portion having a greater surface area below the mount than above the mount.

One aspect of this disclosure relates to a method of manufacturing a fan blade according to this disclosure. The method comprises extruding the fan blade from aluminum. The method may further include the step of attaching the fan blade formed by the extruding step to a hub of a ceiling fan.

According to a further aspect of this disclosure, a winglet for connecting to a fan blade for a ceiling fan is provided. The winglet comprises a body including a mount for connecting to the fan blade. The body further includes a generally vertical portion having a greater surface area below the mount than above the mount. In one embodiment, a first distance from a lowermost edge of the generally vertical portion to a lower edge of the mount is greater than a second distance from an upper edge of the generally vertical portion at an apex at an upper edge of the mount.

According to yet another aspect of the disclosure, a winglet for a fan blade is provided. The winglet comprises a body adapted for connecting to the fan blade. The body includes a portion angled in a vertical direction and also angled (or curved) in plan view.

In one embodiment, the body comprises an airfoil cross-section along at least the angled portion. The portion may include a leading edge of the body. Alternatively or additional, the portion may include a trailing edge of the body.

Still a further aspect of the disclosure relates to a winglet for attachment to a fan blade. The winglet includes a leading edge angled in a vertical direction and angled or curving in plan view. The winglet may further include a trailing edge angled in the vertical direction and angled or curving in plan view.

Yet another aspect of the disclosure relates to a winglet for a fan blade. The winglet comprises a body including a portion having a cross-sectional shape corresponding to a cross-sectional shape of the fan blade. The portion of the winglet may comprise an airfoil shape. Another aspect of the disclosure relates to a fan blade. The fan blade comprises a body. A winglet is adapted to be attached to the body. The winglet includes a portion having an airfoil shape in cross-section. The portion of the winglet is radially outwardly of an end of the body. The body may be at least partially hollow, and wherein the winglet includes a portion adapted for insertion into the at least partially hollow body. The body may have an airfoil shape in cross-section.

### BRIEF DESCRIPTION OF THE DRAWING FIGURES

FIG. 1 is a perspective view of an exemplary ceiling fan;

FIG. 1A is a plan view of a hub for supporting a plurality of fan blades;

FIG. 2 is a perspective view of a cross-section of a partially hollow fan blade having an airfoil shape and a solid depending portion according to one aspect of the disclosure;

FIG. 2A is a side view of the fan blade of FIG. 2;

FIG. 3 is a top view of a fan blade;

FIG. 3A is a cross-sectional view taken along line 3A-3A of FIG. 3;

FIG. 4 is a view comparing two different cross-sectional geometries of fan blades;

FIGS. 5 and 5A are graphs;

FIGS. 6, 6A, 6B, 6C, 6D, 6E and 6F are various views of a winglet according to another aspect of this disclosure;

FIG. 7 is an enlarged side view of a winglet according to this disclosure;

FIG. 8 is a perspective view of another exemplary ceiling fan;

FIGS. 9, 9A, 9B, 9C, 9D, 9E, 9F and 6G are various views of a winglet according to another aspect of this disclosure; and

FIGS. 10, 10A, 10B, 10C, and 10D are various views of an air modifying structure according to another aspect of this disclosure.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a blade retention system for a fan is provided.

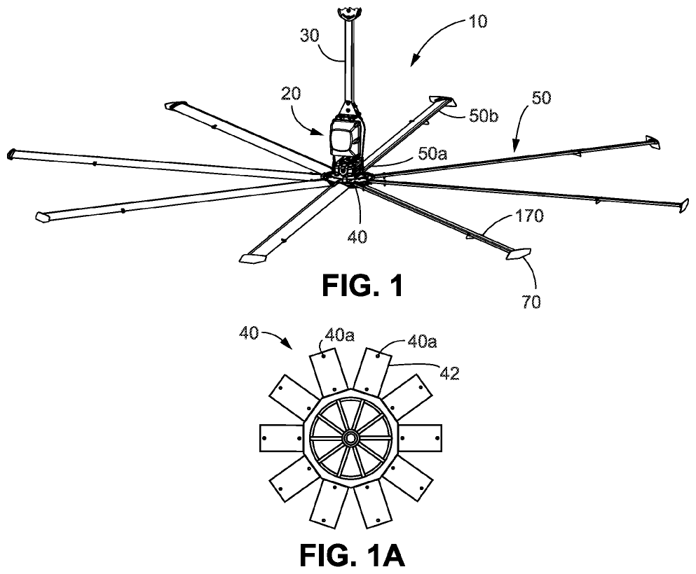

As shown in FIG. 1, a fan 10 includes a motor 20, a support 30, a rotatable hub 40 and a plurality of fan blades 50 having a winglet 70 at its distal or free end. The support 30 is configured to be coupled to a surface or other structure at a first end such that fan 10 is substantially attached to the surface or other structure. The support 30 of the illustrated embodiment comprises an elongated tubular structure that couples the fan 10 to a ceiling, though it should be understood that the support 30 may be constructed and/or configured in a variety of other suitable ways as will be apparent to one of ordinary skill in the art in view of the teachings herein. By way of example only, support 30 need not be coupled to a ceiling or other overhead structure, and instead may be coupled to a wall or to the ground. For instance, support 30 may be positioned on the top of a post that extends upwardly from the ground. Alternatively, support 30 may be mounted in any other suitable fashion at any other suitable location.

The motor 20 may comprise an AC induction motor having a drive shaft, though it should be understood that motor 20 may alternatively comprise any other suitable type of motor, such as for example a permanent magnet brushless DC motor, a brushed motor, an inside-out motor, etc., In the present example, motor 20 is fixedly coupled to support 30 and rotatably coupled to hub 40. Furthermore, motor 20 is operable to rotate hub 40 and the plurality of fan blades 50.

As perhaps best illustrated in FIG. 1A, hub 40 of the present example comprises a plurality of radially outwardly extending arms or tabs 42 serving as hub mounting members, or mounts. Each tab 42 is shown attached to the hub 40 via fasteners. Each tab 42 further includes a plurality of mounting holes 40a such that fan blades 50 are fixedly coupled to each corresponding tab 42 and such that fan blades 50 rotate unitarily with hub 40.

An exemplary fan blade 50 comprises a first or proximal end 50a and a second or distal or free end 50b. Each fan blade 50 is coupled to hub 40 as seen in FIG. 1 at the first end 50a, such as by receiving one of the arms or tabs 42, and each fan blade 50 extends radially outwardly from hub 40. Hub 40 is further secured to a drive shaft of motor 20 such that hub 40 and the drive shaft rotate unitarily, as do fan blades 50.

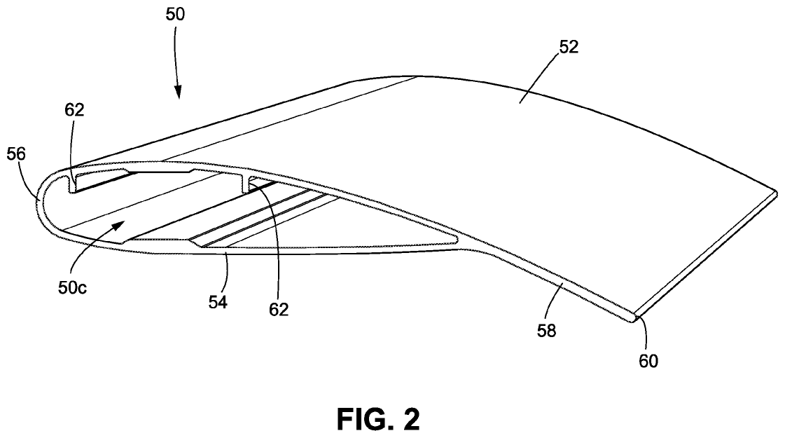

FIG. 2 shows a perspective end view of exemplary fan blade 50 according to one aspect of the disclosure. Fan blade 50 has an upper surface 52 and a lower surface 54, which terminate into leading end portion 56 and trailing end portion 58, including a trailing edge 60. With the exception of a solid trailing end portion 58, the fan blade 50 may be hollow, and thus includes an interior passage 50c, which may extend from the proximal end 50a to the distal end 50b. The fan blade 50 has an airfoil shape in cross-section.

As shown in FIG. 2 as well as in FIG. 2A, trailing end portion 58 depends relative to portion of lower surface 54 proximate thereto. Thus, this end portion 58 depends from a plane aligned with this surface when mounted to the tab 42, and extends to a location lower than the surface 54 when mounted to the tab 42. The depending portion 58 may form an angle relative to a plane aligned with and generally parallel to the lower surface 54 of approximately 25° (angle α, and thus having a complementary angle of approximately 155°), but this may vary. Trailing end portion 58 may be solid and have a thickness T of approximately 0.1 inches, but could be larger or smaller depending on the particular application. Other suitable trailing end portions 58 configurations will be apparent to those of ordinary skill in the art.

In the present example, a plurality of ribs 62 and bosses 64 are located inside a hollow portion of the fan blade 50. As shown, when tab 42 is inserted into fan blade 50, ribs 62 and bosses 64 are positioned such that they contact one or more of the top surface, bottom surface, leading edge, and/or trailing edge of tab 42. Ribs 62 and bosses 64 thus provide a snug fit between fan blade 50 and tab 42. Alternative configurations for fan blade 50, including but not limited to those affecting the relationship between fan blade 50 and hub mounting member 12, will be apparent to those of ordinary skill in the art.

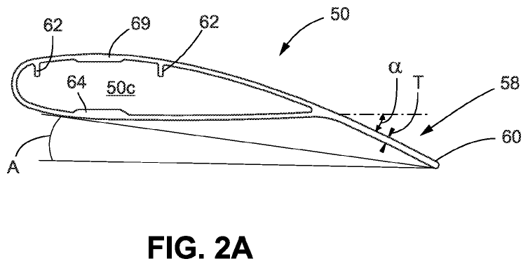

In the present example, fan blades 50 may be mounted to tabs 70 by fasteners, such as bolts or screws, positioned in or through the holes 40a. As shown in FIG. 3, the proximal end portion 50a of each fan blade 50 may include one or more apertures 64a. These apertures 64a may extend through the top and bottom surface through bosses 64 in an aligned manner for receiving a fastener or other bolt.

As shown, a plurality of apertures 64a may be provided in each surface for receiving a plurality of fasteners. However, it should be understood that alternative mounting arrangements may be employed. For example, fan blades 50 may be mounted by adhesives, by friction fit, and/or by any combination of suitable mountings as will be apparent to one of ordinary skill in the art in light of the teachings herein. It should also be understood that an interface component may be provided at the interface of each fan blade 50 and hub 40.

Fan blade 50 may be approximately 1, 2, 3, 4, 5, 6, 7, 8, 9, 10, 11, 12, 13, or 14 feet long, or any value therebetween. Alternatively, fan blade 50 may be of any other suitable length. In one embodiment, fan blade 50 and hub 40 are sized such that a fan 10 comprising fan blades 50 and hub 40 has a diameter of approximately 24 feet. In another embodiment, fan blade 50 and hub 40 are sized such that a fan comprising fan blades 50 and hub 40 has a diameter of up to approximately 24 feet, or greater than 24 feet, such as for example 30 feet. Other suitable dimensions will be apparent to those of ordinary skill in the art.

It will be appreciated that all cross sections along the length of fan blade 50 need not be identical. In other words, the configuration of fan blade 50 need not be uniform along the entire length of fan blade 50.

Fan blade 50 may have a zero or non-zero angle of attack. By way of example only, when mounted to hub mounting member or tab 42, fan blade 50 may have an angle of attack in the range of approximately −1° to 7°, inclusive; between −2° and 10°, inclusive; or approximately 7°, 8°, 9°, 10°, 11° or 13° by way of example only. Of course, fan blade 50 may have any other suitable angle of attack.

Fan blade 50 may be substantially straight along its length, and the angle of attack may be provided by having hub mounting member 12 with the desired angle of attack. Alternatively, the angle of attack of hub mounting member or tab 42 may be zero, and an angle of attack for fan blade 50 may be provided by a twist in fan blade 50. In other words, fan blade 50 may be substantially straight along the length to which hub mounting member or tab 42 extends in fan blade 50, and a twist may be provided to provide an angle of attack for the remaining portion of fan blade 50. Such a twist may occur over any suitable length of fan blade 50; e.g. the entire remainder of fan blade 50 length has a twist; or the twist is brief, such that nearly all of the remainder of fan blade 50 is substantially straight; etc. Still other suitable configurations and methods for providing an angle of attack for all or part of fan blade 50 will be apparent to those of ordinary skill in the art. In addition, all or any portion of fan blade 50 may have one or more twists for any purpose.

As can be appreciated, the provision of a solid trailing end portion 58 depending to a location below a lower surface of the fan blade 50 allows for the angle of attack to be specially tuned. This may be achieved, for example, by adjusting the angle of this end portion 58 relative to the hollow portion of the fan blade 50, without otherwise altering the shape of the fan blade 50. This allows for adjustments to the performance to be made without altering the manner in which the fan blade 50 interfaces with the hub mounting member or tab 42. As an example, and as indicated in FIG. 2A, the angle of attack A may be determined by the angle measured between a line across the two points of contact on the lower surface of the fan blade 50 and a generally horizontal plane aligned with (e.g., generally parallel to) the lower surface of the fan blade when mounted to the hub 40. This arrangement allows the leading edge and mounting profile of the fan blade 50 to remain constant, while the geometry or length of the trailing end portion 58 can be adjusted to increase/decrease the angle of attack to adjust the airflow rate, as desired for a given application.

In the specific case of forming an airfoil as an aluminum extrusion for use as a fan blade 50, limitations exist as to the maximum size most domestic suppliers can accommodate. As examples, one foil profile developed to achieve the target increase in airflow rate (009640) was larger than the capacity of the common extrusion press dimensions. In addition, increasing the chord length from 6.26″ (007930) resulted in an increased the length of unsupported cross section. Adding a vertical feature in the center of the extrusion connecting the top and bottom surfaces is possible, but may result in an increase in the principal moment of inertia, which could lead to increased stress on the hub and decrease in fatigue resistance for the hub and blade system.

To address the maximum press dimension capacity and unsupported cross section issue, a version referenced herein as 007930_mod was designed and a computational flow dynamics (CFD) study conducted to confirm similar airflow characteristics. The 007930_mod profile was then refined to improve the geometry (wall thickness, uniformity, appearance, mating features to spar (tab 42)) and was finalized as the 010348 and 010349 profiles. During this refinement process, the principal moment of inertia and cross sectional area of an existing (“Elipto”) airfoil was used as the design target to ensure good fatigue resistance of the foil and hub system was maintained.

Tooling was produced for both profiles to support final system testing and empirical data to be collected. Based on the desired efficiency and motor load, the 010348 version was selected as the preferred embodiment (“PFX4”))

| | | | Principal | | | | | |
|---|---|---|---|---|---|---|---|---|
| Final | Development | | Moment | Cross- | | Angle of | | |
| BAF Part | Reference | | of Inertia | Sectional | | attack | | Max |
| Number | Number | | (x) | Area | I/A | (tangential) | Chord | Camber |
| (007930) | | Elipto | 0.1122 | 103.81 | 0.1081 | 7.08 | 6.26 | |
| | 009640 | | 0.1228 | 1.1392 | 0.1078 | 8.36 | 7.13 | |
| | 007930_mod | | 0.1091 | 0.9438 | 0.1156 | 8.36 | 6.5 | |
| | JW0321-05 | | 0.1110 | 0.9973 | 0.1113 | 8.36 | 6.5 | |
| | JW0321-05_B | | 0.1100 | 0.9956 | 0.1105 | 8.36 | 6.5 | |
| (010348) | JW0321-05_C | | 0.1085 | 0.9951 | 0.1090 | 8.00 | 6.5 | 0.471 |
| (010349) | JW0321-05_D | | 0.1129 | 0.9971 | 0.1132 | 9.00 | 6.5 | 0.507 |

Results of 009640 vs. 007930_mod foil Ansys CFD study to confirm similar airflow rate and shaft torque:

| 0.075 | Speed [RPM] | Lift [lbf] | CFM | Torque [lbf-ft] |
|---|---|---|---|---|
| PX3 | 65 | 100.68 | 265191 | 164.79 |
| V2 - 009640 | 65 | 122.96 | 293064 | 208.68 |
| 007930_mod | 65 | 125.50 | 296080 | 216.1 |

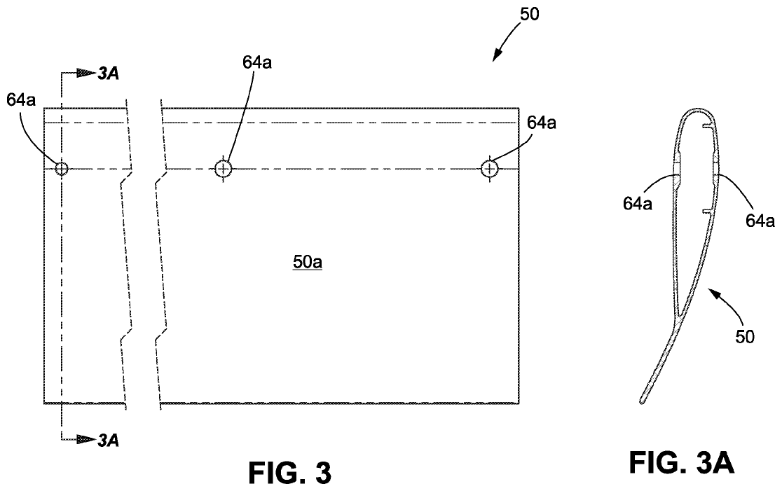

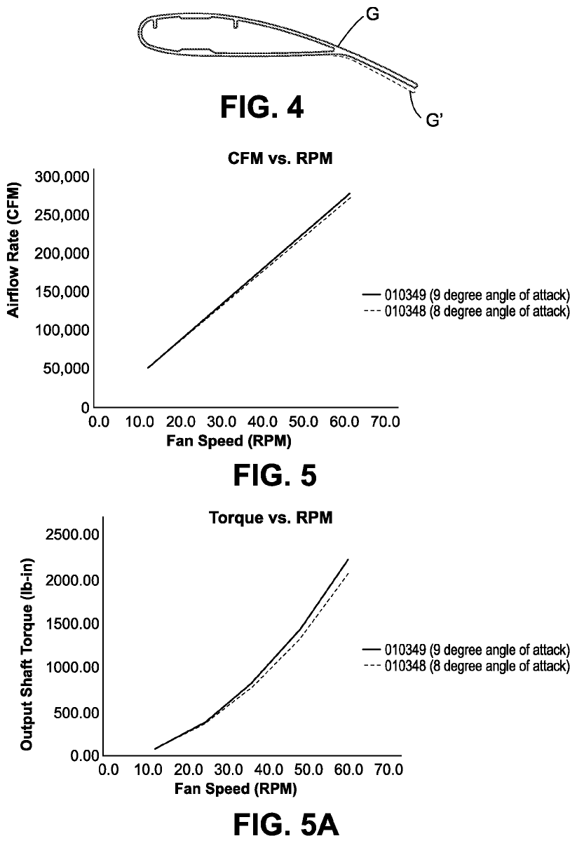

Another benefit of the depicted foil profile design is that it allows the leading edge and hub mounting features to remain similar, and only the trailing edge geometry to be adjusted to adjust the angle of attack based on the airflow rate and maximum RPM desired for a large diameter fan application. FIG. 3 illustrates the trailing edge geometry change between the 010348 (G) and 010349 (G′). FIG. 4 graphically illustrates the increase in airflow rate at same fan operating speeds for these two versions (in an exemplary 24 ft 8-blade fan configuration), and FIG. 5 graphically illustrates the change in output shaft torque and fan speed for these two versions (also in an exemplary 24 ft 8-blade fan configuration).

In some instances, arrangements are used to provide for the retention of hub 40 and fan blades 50 in the event of a structural failure for part of fan 10. For instance, to prevent the inadvertent separation of hub 40 from motor 20, one or more attachments, such as retainers, may be provided by means of which hub 40 may engage an additional part of motor 20 and/or support 30. Thus, in the event of a separation of the drive shaft from hub 40—the primary attachment between hub 40 and motor 20—the one or more safety attachments prevent the hub 40 from completely disconnecting relative to motor 20 and/or support 30. Some examples of such attachments are disclosed in the various references cited herein.

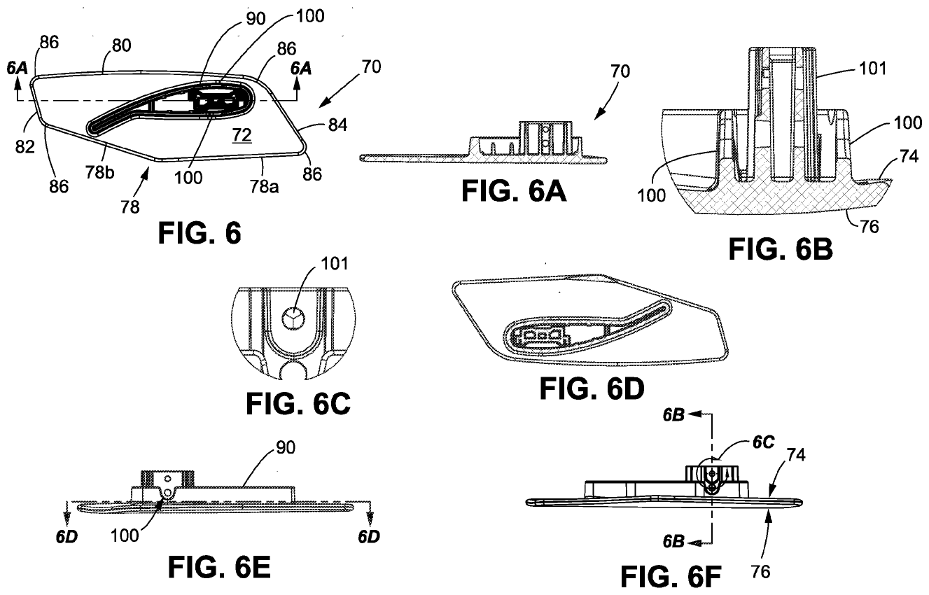

Fan blades 50 of the present example are sometimes termed “airfoils” in view of their cross-sectional shape, and may further include a variety of modifications. By way of example only, each fan blade 50 further comprises a winglet 70 coupled to the second, distal end 50b of fan blade 50 as illustrated in FIG. 6.

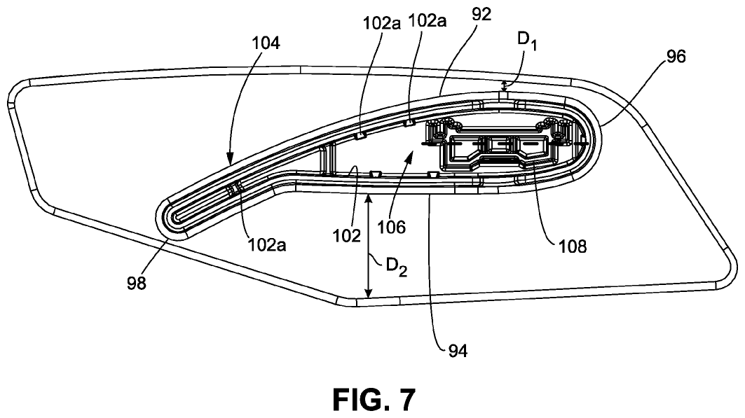

Referring now to FIGS. 6, 6A, 6B, 6C, 6D, 6E, 6F, and 7, one winglet 70 of the present disclosure includes generally vertical member 72. Vertical member 72 comprises a rounded concave inner surface 74 and rounded concave outer surface 76. Other suitable configurations for inner surface 74 and outer surface 76 will be apparent to those of ordinary skill in the art. In the present example, the perimeter of vertical member 72 is defined by lower edge 78 having a front portion 78a and a rear portion 78b, upper edge 80, rear edge 82, and front edge 84.

Each edge 78, 80, 82, and 84 meets generally at respective corner 86. Thus, in the present example, vertical member 72 has four corners 86. As shown, each corner 86 is rounded. Accordingly, the term “corner,” as that term is used herein, shall not be read to require a sharp angle. In other words, a corner need not be limited to a point or region at which a pair of straight lines meet or intersect. While in the present example vertical member 72 is described as having four corners, it will be appreciated that vertical member 72 may have any suitable number of corners 86. The overall shape of the winglet 70 is deemed to be a matter of ornamentation.

As perhaps best shown in the enlarged view provided by FIG. 7, winglet 70 of the present example further includes winglet mounting member 90. This mounting member 90 extends substantially perpendicularly from inner surface 74 of generally vertical member 72. As shown, winglet mounting member 90 is configured similar to a cross-sectional shape of the blade 50. Winglet mounting member 90 has top surface 92 and bottom surface 94, which each terminate into leading edge 96 and trailing edge 98.

In addition, as shown in FIGS. 6 and 6B, each winglet mounting member 90 includes openings 100 formed through top surface 92 and bottom surface 94. In the present example, each opening 100 is sized to receive fastener 26. Winglet mounting member 90, or mount, is configured to receive an end of fan blade 50, and may thus have a matching or corresponding shape (e.g., an airfoil cross-section). Those of ordinary skill in the art will appreciate that winglet mounting members 90 may be provided in a variety of alternative configurations.

As can be appreciated, the winglet mounting member 90 also includes an inner surface 102 corresponding to the outer surface of the fan blade 50. This includes a narrow portion 104 for receiving the trailing end portion of the fan blade 50, and a wider portion 106 for receiving the remainder of the fan blade 50. To ensure a snug fit, bosses 102a may be provided along the inner surface 102. A retainer 108 may also be provided for anchoring with a connector for connecting with the hub 40 to aid in preventing full detachment of the fan blade 50, which retainer 108 may also receive and engage fasteners passing through one or more of the openings 100 in the winglet 70. An opening 101 may also be provided for receiving a fastener for connecting the winglet to the fan blade 50.

It can also be appreciated that the winglet 70 is dimensioned vertically such that a substantially longer portion of the winglet extends below the fan blade 50 as compared to a shorter portion extending above the fan blade 50 at or adjacent the apex thereof that is, the highest point relative to the winglet 70. This is illustrated by smaller vertical dimension D1 and a substantially larger vertical dimension D2.

The surface area of the winglet 70 below the fan blade 50 when mounted thereto may also be greater than the surface area of the winglet 70 above the fan blade 50. Accordingly, the surface area of the surface of the winglet 70 along the vertical portion extending below the mounting member 90 is greater than the surface area of the surface above the mounting member. The maximum forward extent of the winglet 70 relative to the forward or leading end portion 56 of the fan blade 50 when mounted to the winglet 70 may be substantially equal to the maximum extent of the winglet 70 relative to the rear or trailing edge 60 of the fan blade 70 when so-mounted.

In one embodiment, winglet 70 is formed from homogenous continuum of molded plastic. However, it will be appreciated that winglet 70 may be made from a variety of materials, including but not limited to any suitable metal and/or plastic, and may comprise a plurality of pieces. In addition, it will be appreciated that winglet 70 may be made by any suitable method of manufacture.

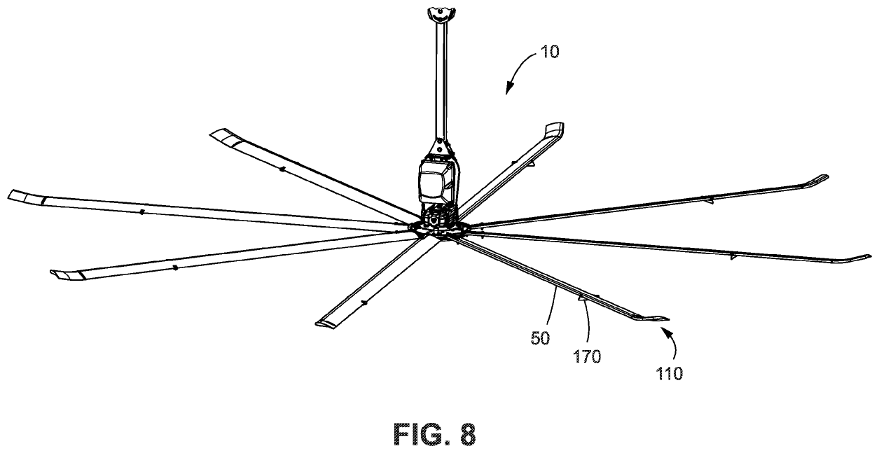

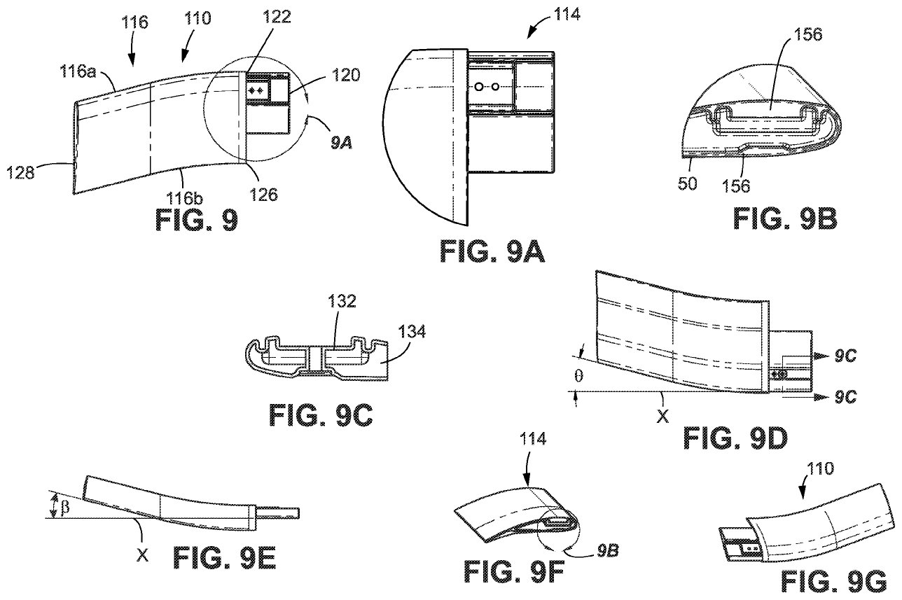

According to a further aspect of the disclosure, and with reference to FIGS. 8, 9, 9A, 9B, 9C, 9D, 9E, 9F, and 9G, an angled fan blade extension 110 includes attachment portion 114 and angled portion 116. Attachment portion 114 has a proximal end 120 and a distal end 122. Angled portion 116 has a proximal end 126 and a distal end 128. The proximal end 126 of angled portion 116 is secured to the distal end 122 of attachment portion 114. The angled portion 116 may also be curved in plan view, as shown in FIG. 9 (which is considered to be a more specific form of the term “angled,” as contrasted with straight) and, in particular, includes a curved leading edge 116a and a curved trailing edge 116b (which may be reversed depending on the direction of fan rotation). In other words, when view from above, the leading and/or trailing edge 116a, 116b of the angled portion also forms an angle relative to an axis X extending radially outward from the hub 40 and parallel to a longitudinal axis of the fan blade 50.

In some versions, attachment portion 114 and angled portion 116 are formed separately, then joined together using fasteners e.g., bolts, etc., interlocking components or features, press fitting, adhesives, welding, or any other suitable devices, structures, or techniques. In some other versions, attachment portion 114 and angled portion 116 are formed as a unitary construction e.g., molded as a homogenous continuum of material, etc. Other ways in which attachment portion 114 and angled portion 116 may be formed will be apparent to those of ordinary skill in the art in view of the teachings herein. The proximal end 120 of attachment portion 114 is secured to the distal end 50b of fan blade 50 as described in greater detail below.

In some versions, the association of angled fan blade extension 110 to fan blade 50 provides a continuation of the cross sectional profile of fan blade 50. However, rather than continuing along the axis of fan blade 50, the association of angled fan blade extension 110 to fan blade 50 creates an upwardly curved angle configured to create a pattern of outward spread in the output airflow column. It will be appreciated by those of ordinary skill in the art that other angular orientations may be used.

Along angled portion 116, the aerodynamic properties and angled orientation of angled portion 116 may tend to deflect the air downward and outward in a direction perpendicular to the axis of angled portion 116 of angled fan blade extension 110. By way of example only, the angle of angled fan blade extension 110 may be such to direct an outward flow of air at about the height of the fan. Also by way of example only, the angled fan blade extension 110 may be oriented such that the association of angled fan blade extension 110 to fan blade 50 creates a downwardly curved angle configured to create a pattern of inward spread in the output airflow. In some versions, the angle between fan blade 50 and angled portion 116 of angled fan blade extension 110 may have a tendency to disrupt vortices which form at distal end 128 of angled portion 116 of fan blade extension 110.

In some versions, as shown in FIG. 9E, a vertical angle β between an axis X of fan blade 50 and the axis of angled portion 116 of angled fan blade extension 110 may be less than approximately 30 degrees, inclusive, and approximately 14 degrees, inclusive. The angled fan blade extension 110 may also be angled in a generally horizontal plane at an angle θ relative to the axis X of the fan blade 50 (FIG. 9D). This angle may be provided only on a leading edge 116a, only on a trailing edge 116b, or on both edges as shown. The angle may also be applied to only a portion of the angled fan blade extension 110.

In some versions, angled fan blade extension 110 is made of a lightweight polymer material to minimize its weight. Alternatively, any other suitable material or materials may be used, including but not limited to any suitable plastic, metal, composite, alloy, or combinations thereof. Angled fan blade extension 110 may comprise a hollow form having a hollow space 134 defined by a relatively thin wall 132, to further minimize the weight of angled fan blade extension 110 while maintaining the full detail of the desired fan blade cross section form. Alternatively, angled fan blade extension 110 may be solid or have a substantially solid exterior and partially solid interior. It will also be appreciated that angled fan blade extension 110 may initially comprise a hollow form, with a material being used to fill the hollow form to any suitable degree.

The manufacturing process used in the production of angled fan blade extension 110 may include blow molding, rotational molding, injection molding, permanent mold casting, die-casting, stamping, welding, or any other suitable manufacturing processes, including combinations thereof. It will also be appreciated that angled fan blade extension 110 may have any suitable cross section form. For instance, at least a portion of an angled fan blade extension 110 may have an airfoil-shaped cross-section. In one particular example, the cross sectional form similar to the cross section form of a fan blade 50 to which it is secured (i.e., the cross-section shown in FIG. 2A or 2B). At least a portion of an angled fan blade extension 110 may also have a cross section form that differs from the cross section of a fan blade 50 to which it is secured.

In addition, distal end 128 of angled portion 116 of angled fan blade extension 110 may be substantially flat, rounded e.g. convex, etc., tapered, or have any other suitable configuration. In the example shown, angled portion 116 of angled fan blade extension 110 has an arcuate cross section form with a rounded distal end 128 of angled portion 116. For instance, angled fan blade extension 110 may have upper and lower surfaces similar to fan blade 50.

Angled fan blade extension 110 may be secured to fan blade 50 using any suitable technique. By way of example only, the end of fan blade 50 may be substantially hollow, and angled fan blade extension 110 may comprise attachment portion 114 configured to be inserted into the end of fan blade 50. Alternatively, the end of attachment portion 114 of angled fan blade extension 110 may be substantially hollow, and the end of fan blade 50 may be configured to be inserted into the end of attachment portion 114.

Still yet, attachment portion 114 may be configured to slide over a portion of the end of fan blade 50 to establish connectivity. Furthermore, angled fan blade extension 110 may lack an attachment portion 14 altogether. For instance, angled portion 116 may be secured directly to fan blade 50 by separately forming angled portion 116 and fan blade 50, then joining them together using fasteners e.g., bolts, etc., interlocking components or features, press fitting, adhesives, welding, or any other suitable devices, structures, or techniques. In some other versions that lack an attachment portion 114 altogether, angled portion 116 and fan blade 50 may be formed as a unitary construction e.g., molded as a homogenous continuum of material, etc.

It will also be appreciated that one or more fasteners may be used to secure attachment portion 114 to fan blade 50, including but not limited to one or more pins, screws, bolts, adhesives, nails, welds, etc. In yet another version, fan blade 50 and attachment portion 114 of angled fan blade extension 110 are integrally formed of a homogenous continuum of material. For instance, angled fan blade extension 110 may simply comprise the distal end 50b of fan blade 50 bent upward. It will be appreciated by those of ordinary skill in the art that such a bent configuration may include bending the distal end 50b of fan blade 50 in a variety of directions to achieve the desired angular configuration.

In some versions of angled fan blade extension 110, attachment portion 114 has substantially flat upper and lower surfaces e.g., defining substantially flat, substantially parallel planes, etc. For instance, attachment portion 114 may be configured similar to mounting members or tabs of hub 40. Alternatively, attachment portion 114 may have a center region and/or upper and lower surfaces having a curvature that is substantially similar to or complements a curvature of one or both fan blade surfaces 52, 54. Furthermore, upper and lower surfaces of attachment portion, regardless of whether they are curved or substantially flat, may also include one or more recesses, relief features, or other features configured to engage with bosses 156 inside fan blade 50. In some versions, a pattern of thicker and thinner sections across attachment portion 114 may provide additional stiffness and/or resistance to crushing. Other suitable configurations and features for an attachment portion 114 will be apparent to those of skill in the art in view of the teachings herein.

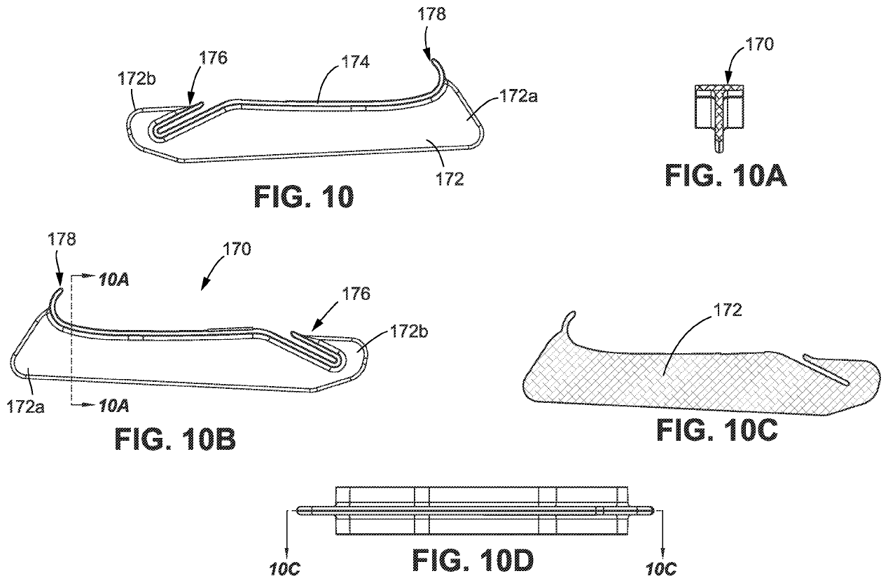

According to a further aspect of the disclosure, and with reference to FIGS. 10, 10A, 10B, 10C, and 10D, an air attachment 170 comprises a vertical fin 172 and a base 174. Base 174 is configured to permit air attachment 170 to be removably secured to the lower surface of a fan blade 50. In the present example, vertical fin 172 and base 174 are formed unitarily together as a single piece of resilient plastic material. For instance, fin 172 and base 174 may be molded together. Alternatively, fin 172 and base 174 may be formed separately then later joined together using any suitable devices or techniques. Similarly, fin 172 and base 174 may be formed of any desirable material or combinations of materials (e.g., plastic base 174 with metal fin 172, etc.), and may have any desired properties in addition to or in lieu of having resilient properties. The fin 172 may have any desired shape.

In the present example, the resilience of air attachment 170 permits it to be snapped on over fan blade 50. In particular, the resilience of the material permits base 174 to deform to pass over the edge of fan blade 50 and then return to its original shape to lock it into place. Base 174 has clip ends 176, 178), which provide a snug fit against the trailing and leading edges of fan blade 50. In one merely exemplary method of securing air attachment 170 to fan blade, trailing edge clip end 176 is first engaged with trailing edge of fan blade 50. Air attachment 170 is then rotated toward leading edge 17 of fan blade 50 until leading edge clip end 178 deforms away from leading edge to clear leading edge of fan blade 50. Upon clearing leading edge of fan blade 50, leading edge clip end 178 snaps back to securely grip leading edge of fan blade 50. The resilience of air attachment 170 and the relative, complementary cross-sections of air attachment 170 and fan blade 50 may substantially prevent air attachment 170 from sliding along the length of fan blade 50 during operation of fan 10. That is, the resilient bias of air attachment 170 may increase friction between air attachment 170 and fan blade 50 once air attachment 170 has been installed on fan blade 50. In lieu of or in addition to such a “snap” fitting, air attachment 170 may be secured to fan blade 50 using adhesive, mechanical fasteners, and/or any other suitable components, devices, or techniques.

In another version, each air attachment 170 is substantially rigid, and base 174 is slid onto an end of fan blade 50. For instance, air attachment 170 may be slid onto the hub end of fan blade 50 before fan blade 50 is coupled with hub 40. Alternatively, air attachment 170 may be slid onto the free end of fan blade 50 before a winglet 70 is secured to the free end of fan blade 50. Regardless of whether air attachment 170 is rigid or resilient, in some versions, removal of air attachment 170 may be accomplished by sliding air attachment 170 off either end of fan blade 50. A resilient air attachment 170 may alternatively be detached, or “un-snapped,” from fan blade 50 in some settings, such as by prying or peeling leading edge clip end 178 from leading edge of fan blade 50 or in any other suitable fashion.

In the present example, the interior surface of base 174 has a profile that approximates the corresponding profile of fan blade 50, such that the base 174 is substantially continuously engaged with fan blade 50 across the transverse width of fan blade 50. Furthermore, vertical fin 172 has a profile that complements the profile of fan blade 50. It should be understood, however, that base 174 and fin 172 may each have any other desired profile. Such alternative profiles may have any suitable relationship with, or no relationship at all with, each other and/or the profile of fan blade 50. For instance, fin 172 may be configured such that its vertical height from base 174 is greater near leading edge clip end 178 than the vertical height of fin 172 from base 174 near trailing edge clip end 176. That is, fin 172 tapers down toward trailing edge of fan blade 50. In some other versions, fin 172 is configured such that its vertical height from base 174 is greater near trailing edge clip end 176 than the vertical height of fin 172 from base 174 near leading edge clip end 178. In some such versions, fin 172 may taper down toward leading edge of fan blade 50. Still other suitable configurations for fin 172 will be apparent to one of skill in the art in view of the teachings herein.

As shown, base 174 terminates at clip ends 176, 178, such that a gap is defined between clip ends 176, 178. In other versions, clip ends 176, 178 are omitted, and base 174 continuously defines an opening or aperture for a fan blade 50 to be slid into. Such an opening may have a cross-section that complements the cross-section of fan blade 50 or any other suitable cross-section.

As also shown, fin 172 extends downward from an outer lateral edge of base 174. In some versions, air attachment 170 is installed on fan blade 50 such that fin 172 is positioned closer to hub 40, with base 174 extending toward winglet 70. Alternatively, fin 172 may be positioned such that it is positioned closer to winglet 70 when air attachment 170 is installed on fan blade 50, with base 174 extending toward hub 40. In some other versions, fin 172 is positioned at the center of the width of base 174, or otherwise between outer edges of base 174 (see FIG. 10A cross-section). As yet another merely exemplary variation, fin 172 may extend at an angle. For instance, fin 172 may be angled such that it is closer to hub 40 near leading edge yet closer to winglet 70 near trailing edge, or vice versa. Similarly, while fin 172 defines a substantially right angle with base 174 in the present example, it should be understood that fin 172 may alternatively define an acute or obtuse angle with base 174. Still other suitable ways in which fin 172 may be positioned and/or oriented will be apparent to those of ordinary skill in the art in view of the teachings herein.

In one example, fin 172 includes a leading end portion 172a that extends forward of the leading clip end 176. The leading end portion 172a may have a rounded portion or corner that approximates the shape of the winglet 70, if present. Likewise, the fin 172 may include a trailing end portion 172b that projects rearwardly of the trailing clip end 176, as well as possibly above it, as shown.

Summarizing, this disclosure relates to any one or more of the following items in any combination:

1. A fan blade adapted for connecting to a mount, such as a rotatable hub, comprising:
a body having an airfoil shape in cross-section, the body including a hollow portion having a lower surface and a solid portion depending from the body to a location below the lower surface when the fan blade is connected to the mount.

2. The fan blade of item 1, wherein the body includes an angle of attack between about 8 degrees and about 9 degrees.

3. The fan blade of item 1 or item 2, wherein the body includes a chord length of about 6 inches to about 7 inches.

4. The fan blade of item 3, wherein the chord length is about 6.5 inches.

5. The fan blade of any of items 1-4, wherein the hollow portion comprises one or more mounting bosses for engaging a tab of a hub.

6. The fan blade of any of items 1-5, wherein the solid portion depends at an angle of approximately 25° relative to portion of the lower surface of the hollow portion.

7. The fan blade of any of items 1-6, further including a winglet attached to one end of the body.

8. The fan blade of item 7, wherein the winglet includes a portion having an airfoil shape in cross-section.

9. The fan blade of item 7, wherein the winglet comprises a body including a mount for connecting to the fan blade, the body further including a generally vertical portion having a greater surface area below the mount than above the mount.

10. A method of manufacturing, comprising extruding the fan blade of any of items 1-9 from aluminum.

11. The method of item 10, further including the step of attaching the fan blade formed by the extruding step to a hub of a ceiling fan.

12. A ceiling fan including one or more of the fan blades of any of items 1-9.

13. A winglet for connecting to a fan blade for a ceiling fan, comprising:
a body including a mount for connecting to the fan blade, the body further including a generally vertical portion having a greater surface area below the mount than above the mount.

14. The winglet of item 13, wherein a first distance from a lowermost edge of the generally vertical portion to a lower edge of the mount is greater than a second distance from an upper edge of the generally vertical portion at an apex at an upper edge of the mount.

15. A winglet for a fan blade, comprising:
a body adapted for connecting to the fan blade, the body including a portion angled in a vertical direction and angled, such as by curving for example, in plan view.

16. The winglet of item 15, wherein the body comprises an airfoil cross-section along at least the angled portion.

17. The winglet of item 15 or item 16, wherein the portion includes a leading edge of the body.

18. A winglet for a fan blade, comprising:
a body adapted for connecting to the fan blade, the body including a leading edge angled in a vertical direction and angled in plan view.

19. The winglet of item 18, further including a trailing edge angled in the vertical direction and angled or curving in plan view.

20. A winglet for a fan blade, comprising:
a body including a portion having a cross-sectional shape corresponding to a cross-sectional shape of the fan blade.

21. The winglet of item 20, wherein the portion of the winglet comprises an airfoil shape.

22. A fan blade, comprising:
a body; and
a winglet adapted to be attached to the body, the winglet including a portion having an airfoil shape in cross-section.

23. The fan blade of item 22, wherein the portion of the winglet is radially outwardly of an end of the body.

24. The fan blade of item 22 or item 23, wherein the body is at least partially hollow, and wherein the winglet includes a portion adapted for insertion into the at least partially hollow body.

25. The fan blade of any of items 22-24, wherein the body has an airfoil shape in cross-section.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated components, features, characteristics, parameters, integers, or steps, and does not preclude addition of one or more additional components, features, characteristics, parameters, integers, steps, or groups thereof. Each of these terms is considered equivalent in meaning to the phrase “consisting essentially of.” Each of the phrases “consisting of” and “consists of, as used herein, means “including and limited to”. The phrase “consisting essentially of” means that the stated entity or item system, system unit, system sub-unit device, assembly, sub-assembly, mechanism, structure, component element or, peripheral equipment utility, accessory, or material, method or process, step or procedure, sub-step or sub-procedure, which is an entirety or part of an exemplary embodiment of the disclosed invention, or/and which is used for implementing an exemplary embodiment of the disclosed invention, may include at least one additional feature or characteristic” being a system unit system sub-unit device, assembly, sub-assembly, mechanism, structure, component or element or, peripheral equipment utility, accessory, or material, step or procedure, sub-step or sub-procedure, but only if each such additional feature or characteristic” does not materially alter the basic novel and inventive characteristics or special technical features, of the claimed item.

Terms of approximation, such as the terms about, substantially, approximately, generally, etc., as used herein, refer to ±10% of the stated numerical value or as close as possible to a stated condition.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

Although various inventive concepts have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

1. A fan blade adapted for connecting to a hub, comprising:
a body having an airfoil shape in cross-section, the body including a hollow portion having a lower surface and a solid portion depending from the body to a location below the lower surface when the fan blade is connected to the hub.

2. The fan blade of claim 1, wherein the body includes an angle of attack between about 8 degrees and about 9 degrees.

3. The fan blade of claim 1, wherein the body includes a chord length of about 6 inches to about 7 inches.

4. The fan blade of claim 3, wherein the chord length is about 6.5 inches.

5. The fan blade of claim 1, wherein the hollow portion comprises one or more mounting bosses for engaging a tab of the hub.

6. The fan blade of claim 1, wherein the solid portion depends at an angle of approximately 25° relative to portion of the lower surface of the hollow portion.

7. The fan blade of claim 1, further including a winglet attached to one end of the body.

8. The fan blade of claim 7, wherein the winglet includes a portion having an airfoil shape in cross-section.

9. The fan blade of claim 7, wherein the winglet comprises a body including a mount for connecting to the fan blade, the body further including a generally vertical portion having a greater surface area below the mount than above the mount.

10. A method of manufacturing, comprising extruding the fan blade of claim 1 from aluminum.

11. The method of claim 10, further including the step of attaching the fan blade formed by the extruding step to a hub of a ceiling fan.

12. A ceiling fan including one or more of the fan blades of claim 1.

13. A winglet for connecting to a fan blade for a ceiling fan, comprising:
a body including a mount for connecting to the fan blade, the body further including a generally vertical portion having a greater surface area below the mount than above the mount.

14. The winglet of claim 13, wherein a first distance from a lowermost edge of the generally vertical portion to a lower edge of the mount is greater than a second distance from an upper edge of the generally vertical portion at an apex at an upper edge of the mount.

15. A winglet for a fan blade, comprising:
a body adapted for connecting to the fan blade, the body including a portion angled in a vertical direction and angled in plan view.

16. The winglet of claim 15, wherein the body comprises an airfoil cross-section along at least the angled portion.

17. The winglet of claim 15, wherein the portion includes a leading edge of the body.

18. The winglet of claim 17, wherein the leading edge is curved.

19. A winglet for a fan blade, comprising:
a body adapted for connecting to the fan blade, the body including a leading edge angled in a vertical direction and angled in plan view.

20. The winglet of claim 19, further including a trailing edge angled in the vertical direction and angled in plan view.

21. A winglet for a fan blade, comprising:
a body including a portion having a cross-sectional shape corresponding to a cross-sectional shape of the fan blade.

22. The winglet of claim 21, wherein the portion of the winglet comprises an airfoil shape.

23. A fan blade, comprising:
a body; and
a winglet adapted to be attached to the body, the winglet including a portion having an airfoil shape in cross-section.

24. The fan blade of claim 23, wherein the portion of the winglet is radially outwardly of an end of the body.

25. The fan blade of claim 23, wherein the body is at least partially hollow, and wherein the winglet includes a portion adapted for insertion into the at least partially hollow body.

26. The fan blade of claim 23, wherein the body has an airfoil shape in cross-section.
